(19) United States
(12) Patent Application Publication
(10) Pub. No.: US 2015/0320010 A1
(43) Pub. Date: Nov. 12, 2015

(54) METHOD AND BARN FOR KEEPING LIVESTOCK

(71) Applicant: Schippers Europe B.V., Bladel (NL)

(72) Inventor: Martinus Pancratius Maria SCHIPPERS, Bladel (NL)

(21) Appl. No.: 14/651,285

(22) PCT Filed: Dec. 20, 2013
(86) PCT No.: PCT/NL2013/050944

§ 371 Date: Jun. 11, 2015

(30) Foreign Application Priority Data
Dec. 20, 2012 (NL) 2010021
May 24, 2013 (NL) 2010854

(51) Int. Cl. A01K 1/02; A01K 1/01; A01K 1/00

(52) U.S. Cl. CPC A01K 1/0218; A01K 1/0047; A01K 1/0076; A01K 1/0103; A01K 1/0209; A01K 1/0227

(57) ABSTRACT

Method and barn (1) for keeping livestock, wherein the barn is divided into one or more housing areas (10, 20, 30) for multiple-day stays of the animals and one or more treatment areas (40, 50, 60, 70, 80) for a shorter, temporary stay of the animals for veterinary inspection of or caring for the animals by a specialist or carer, wherein the animals are staying in living crates (100, 200) positioned on designated barn positions (16) in the housing areas, wherein the barn is provided with a transport device (140, 400) for moving the living crates between the barn positions and the treatment areas.

### BACKGROUND OF THE INVENTION

The invention relates to a method and a barn for keeping livestock, particularly for factory farming.

In known barns for factory farming the animals are in pens that are permanently installed in the barn. Long passageways have been formed in the barn for supplying food and caring for the animals in the pens. The visual inspection takes place ad hoc, for instance by veterinary specialists. They walk over the long passageways and briefly look into each pen to see whether the animals are healthy and developing properly. Usually all animals in the barn are healthy and the situation in the pens is fine give or take a few exceptions. The specialist will have to walk many kilometres in order to inspect all pens. This involves the risk of the veterinary specialist overlooking an unhealthy animal among the healthy animals during the brief moment when walking past their pens.

It is an object of the invention to provide a method and a barn in which caring for animals takes place efficiently.

### SUMMARY OF THE INVENTION

The invention, according to one aspect, provides a method for keeping livestock in a barn, wherein the barn is divided into one or more housing areas for multiple-day stays of the animals and one or more treatment areas for a shorter, temporary stay of the animals for veterinary inspection of or caring for the animals by a specialist or carer, wherein the animals are staying in living crates located on designated barn positions in the housing areas, wherein the barn is provided with a transport device for moving the living crates between the barn positions and the treatment areas, wherein a computer system including a database is provided in which data are included of the individual barn positions of the living crates and of the individual animals in the living crates, wherein the method comprises monitoring the animals' data in the computer system and on the basis thereof by using the computer system planning a temporary stay of the animals in the living crates in a treatment area for inspection or care, wherein on the basis of said planning the living crates with the animals in them are picked up from the barn position in the housing area by the transport device and in the living crates are positioned in the said treatment area for inspection of or caring for the animals. This application regards animals in living crates, meaning that in one living crate one or several animals could be staying.

According to this method the animals are staying in the living crates positioned in the housing areas, and the veterinary specialist or carer is present in the treatment areas. The animals are taken in their living crate to the specialist or carer only when required, wherein the computer system takes care of the planning. Planning a temporary stay in the treatment areas is carried out by the computer system at living crate level based on the animals' data, thus effecting a high degree of accuracy and ensuring that the veterinary specialist or carer sees all animals. This can be done according to fixed time schedules or be planned ad hoc. Based on automated interpretation of the animals' data a proper pre-selection can be made as regards the necessity of veterinary inspection or care that is more reliable than could be obtained based on a brief glance at the animals when walking past. The computer system thus constitutes an automated management system for the animals in the barn. An additional advantage is that the animals are moved in their familiar living crate. This involves as little stress for the animals as possible and it is hygienic.

In one embodiment the barn is provided with a sensor system for registering the condition data regarding the condition of the living crates or the animals in them in the database, wherein the method comprises the planning of a temporary stay of the animals in the living crates in a treatment area on the basis of the condition data. By means of the sensor system a highly reliable pre-selection can be made.

In one embodiment thereof the sensor system comprises an image recognition system for optical registration of condition data of the individual animals in the living crates, wherein the motion activity is the number of movements or relocations of the animal in the course of time, wherein the method comprises the planning of a temporary stay of the animals in the living crates in a treatment area on the basis of the condition data. The image recognition system is able to watch the individual animals long-term, as a result of which a proper pre-selection can be made on the basis of data gathered over a longer period of time, for instance over several days.

In one embodiment thereof the image recognition system is adapted for the optical registration of the motion activity of the individual animals in the living crates, wherein the method comprises the planning of a temporary stay of the animals in the living crates in a treatment area on the basis of deviating motion activity of the animals in the living crates. In this way it can be detected that an individual animal for instance moves less than average, which may be an indication of an illness or shortage of food.

In one embodiment the image recognition system is adapted for the optical registration of the body temperature of the individual animals in the living crates, wherein the method comprises the planning of a temporary stay of the animals in the living crates in a treatment area on the basis of deviating body temperature of the animals in the living crates. A deviating body temperature may be an indication of fever, which would require the animal to be further examined.

In one embodiment the sensor system comprises a weight sensor for weighing the overall weight of the animals in the living crate, wherein the method comprises the planning of a temporary stay of the animals in the living crates in a treatment area on the basis of a deviating weight of the animals in the living crates. A deviating weight may be an indication of the growth of the animals lagging behind due to illness, which would require the animal to be further examined. Also during a stay in the treatment areas the weight sensor can be used for periodically weighing the animals.

In one embodiment the animals in the living crates are provided with an ear tag having a unique identification, wherein the data of the individual animals have been linked to the unique identification of the ear tags.

The invention, according to a second aspect, furthermore provides a barn for keeping livestock, wherein the barn is divided into one or more housing areas for multiple-day stays of the animals and one or more treatment areas for a shorter, temporary stay of the animals for veterinary inspection of or caring for the animals by a specialist or carer, wherein the animals are staying in living crates positioned on designated barn positions in the housing areas, wherein the barn is provided with a transport device for moving the living crates between the barn positions and the treatment areas. The transport device, which in a preferred embodiment can be remote-controlled or operates autonomously, takes the animals in their living crate from the housing area to the treatment area only when required as already described above.

In one embodiment the barn is provided with a sensor system for registering the condition of the living crates or the animals in them.

In one embodiment the sensor system comprises an image recognition system for the optical registration of the condition of the individual animals in the living crates.

In one embodiment the image recognition system is adapted for the optical registration of the motion activity of the individual animals in the living crates, wherein the motion activity is the number of movements or relocations of the animal in the course of time.

In one embodiment the image recognition system is adapted for the optical registration of the body temperature of the individual animals in the living crates.

In one embodiment the sensor system comprises a weight sensor in the living crates for weighing the weight of the animals in the living crate.

In one embodiment the barn comprises at least one housing area and at least one treatment area, wherein the air temperatures of these areas differ or can each be individually adjusted. In that way the air temperature per area can be optimised for the specific function of said area, such as long-term stay of young adult animals or a short stay of a sow during parturition.

In one embodiment the barn comprises several housing areas, wherein the air temperatures of the housing areas differ or can each be individually adjusted. The housing areas can then be used for animals in different stages of life, such as the first weeks after parturition, the stage in which the animals no longer depend on their mother and the stage in which the young adult animals grow into their slaughter weight. For each category the optimal housing temperature can be maintained.

In one embodiment at least one treatment area is adapted for parturition, wherein the air temperature in said treatment area is higher than in the housing areas. Said treatment area is optimised for parturition, wherein in said area all aids required for that purpose are at hand in order to assist in the parturition.

In one embodiment the living crates comprise a tray having a bottom which is surrounded by upright walls, wherein in the tray a faecal slurry grid is situated above the bottom. The living crates thus form mobile living units the upright walls of which ensure the separation between the animals or groups of animals. When the living crates according to the invention have been removed the barn position and the living crates themselves can be properly cleansed. This is contrary to conventional barns in which the separations are permanently installed and thus hard to cleanse. The tray can also be fully cleansed by taking out the faecal slurry grid and placing it back after cleansing.

In one embodiment the tray is integrally formed, preferably of plastic, so that it can be properly cleansed.

In one embodiment the faecal slurry grid comprises a first frame bearing a grid, wherein the first frame supports on the bottom along or at the upright walls, and the faecal slurry grid freely spans the bottom from the support points so as to form a faecal slurry storage space or faecal slurry tray. The faecal slurry grid only contacts the bottom of the tray at the support points so that dirt accumulation between the faecal slurry grid and the tray is minimised. Quantitatively the support points are situated at a distance from the upright walls of maximally 10% preferably maximally 5% of the spanned width of the tray in that direction.

In one embodiment thereof the first frame is provided with supports that contact the bottom along two opposite upright walls. Considered along the contours of the faecal slurry grid the bottom will then be free from the faecal slurry grid beyond said supports.

In one embodiment thereof the first frame is provided with supports distributed over and contacting the bottom wall along the opposite upright walls, wherein the distributed supports keep an intermediate space open for passage of faecal slurry to the faecal slurry storage space or faecal slurry tray.

In one embodiment the living crate has a second frame for supporting the tray. The living crate can thus be handled at the second frame, so that the tray itself is not exposed to such an additional load.

In one embodiment the second frame supports the bottom of the tray in vertical direction straight below the support points of the faecal slurry grid. The load of the faecal slurry grid including the animals situated thereon is thus directly passed on to the second frame. This involves pressure forces, so without deforming loads on the tray itself.

In one embodiment, in a lowered portion of the bottom, the tray is provided with a faecal slurry discharge opening, which may be provided with a valve. The faecal slurry can thus be discharged in a controlled manner via the faecal slurry discharge opening.

In one embodiment the barn is provided with a faecal slurry discharge device for discharging faecal slurry via the faecal slurry discharge opening, wherein the faecal slurry discharge device is provided with a nozzle or showerhead extending through the faecal slurry discharge opening for hosing the bottom of the tray clean all around.

In one embodiment the faecal slurry grid has a first frame onto which one or several metal or plastic grids have been attached. The frame supports the weight of for instance a heavy sow and her piglets, wherein the grids permit the faecal slurry to pass through to the bottom of the tray.

In one embodiment thereof the first frame and the grids form one unity or element, so that it can be laid in the tray or removed from it as one unity, for instance to be cleansed.

In one embodiment the faecal slurry grid is provided with a heater below one or several grids. The heater ensures a heated zone on which for instance newly born piglets can lie down during suckling.

In one embodiment the heater comprises a circulation pipe for connection to a hot water supply, wherein the circulation pipe is attached to the frame or to one or several grids. The hot water supply may be a common heat source for instance for all living crates that are in a treatment area adapted for parturition.

In one embodiment the faecal slurry grid is provided with a rinsing pipe having nozzles oriented all around or oriented towards the grids or oriented downwards towards the bottom. The rinsing pipe may be connected to a supply for rinse water to which a cleansing agent or disinfectant has been added. In that way the grids can be rinsed clean at the bottom side and faecal slurry that has seeped to the bottom can be flushed away.

In one embodiment the circulation pipe and/or rinsing pipe if present is attached to the frame or the grids by means of connections distributed over the length, wherein said grids, the frame and the pipes are enveloped by a continuous galvanic protective layer or synthetic coating. The frame including the grids and metal pipes thus form one unity that has a long-term resistance against the faecal slurry and urine of the animals in the living crate.

In one embodiment the living crate comprises a sow's pen as a result of which the faecal slurry grid is divided into a first grid path and a second grid path extending beyond the sow's pen, wherein the first grid path preferably is wider than the opposite second grid path. The sow's pen prevents the sow from lying down on her piglets, wherein the piglets themselves are able to walk about the first grid path and the second grid path. The piglets are able to lie down on the wider first grid during suckling.

In one embodiment, in one sidewall, the plastic tray has an entrance to the sow's pen, wherein in its bottom the plastic tray comprises a faecal slurry channel extending underneath the sow's pen, which faecal slurry channel debouches in the direction of the entrance into a wider faecal slurry tray, wherein the bottom underneath the first grid path and second grid path is situated elevated relative to the faecal slurry channel and the faecal slurry tray and has a slope in the direction of the faecal slurry channel and the faecal slurry tray. The sow will be allowed to enter the sow's pen head first through the entrance. The faecal slurry will mainly be from the sow, as she produces relative much faecal slurry. It will drop directly into the faecal slurry tray. The other faecal slurry will be from her piglets, which via the slope and the faecal slurry channel also ends up in the faecal slurry tray. The piglet faecal slurry can be urged into the faecal slurry channel by means of said nozzles on the rinsing pipe.

In one embodiment, below the upright walls, the tray has an offset part which on the outside of the tray forms preferably parallel extending support edges, with which the plastic tray sits on the second frame, wherein the faecal slurry grid sits on the inner side of the offset part. The plastic tray itself is thus confined between the supporting parts of the second frame. The weight of the faecal slurry grid having for instance the weight of a sow and her piglets thereon will at that location be directly passed on to the second frame so that the plastic tray itself will hardly be loaded by said weight.

In one embodiment the tray comprises two longitudinal walls and two transverse walls, which according to round corners merge into each other, wherein the corners have a radius of at least 100 mm. The large radius guides the young piglets when walking around in the tray, as a result of which they do not walk around at a loss. The large radius furthermore enhances the cleansability of the tray.

In one embodiment the transport device comprises first rails extending along the barn positions, a first transport carriage moveable over said rails, second rails extending in the barn positions and a second transport carriage moveable over them, wherein the first transport carriage is provided with an accommodation space for accommodation of the second transport carriage from the second rails. The living crates can be brought in front of the planned barn position by the first transport carriage, after which the second transport carriage puts the living crate at the barn position.

In one embodiment the living crates sit on the barn position on the second rails, wherein the second transport carriage is provided with a lifting platform for lifting the positioned living crate above the second rails.

According to a third aspect the invention furthermore provides a living crate for keeping livestock in a barn, comprising a tray having a bottom which is surrounded by upright walls, wherein in the tray a faecal slurry grid is situated above the bottom. The living crate has the advantages as already described above.

The aspects and measures described in this description and the claims of the application and/or shown in the drawings of this application may where possible also be used individually. Said individual aspects may be the subject of divisional patent applications relating thereto. This particularly applies to the measures and aspects that are described per se in the sub claims.

### SHORT DESCRIPTION OF THE DRAWINGS

The invention will be elucidated on the basis of a number of exemplary embodiments shown in the attached drawings, in which:

FIGS. 1A and 1B show an isometric view and a top view of a barn according to the invention of which the roof and parts of the exterior walls have been left out to show its various housing areas and treatment areas;

FIG. 2 shows an isometric view of a first living crate for pigs according to the invention as used in the barn according to FIG. 1A;

FIG. 3 shows a detail of the interior of the barn as indicated by circle III in FIG. 1B, including a few living crates with piglets;

FIG. 4 shows a veterinary inspection lane in a first treatment area in the barn according to FIGS. 1A and 1B;

FIG. 5 shows an ear tag lane in a second treatment area in the barn according to FIGS. 1A and 1B;

FIGS. 6A-6H consecutively show three isometric views, an exploded view, the various exploded parts and a detailed cross-section of a second living crate according to the invention as used in the pig sty according to FIG. 1A; and

FIGS. 7A-7D show details of a storage system as used in the barn according to FIG. 1A.

### DETAILED DESCRIPTION OF THE DRAWINGS

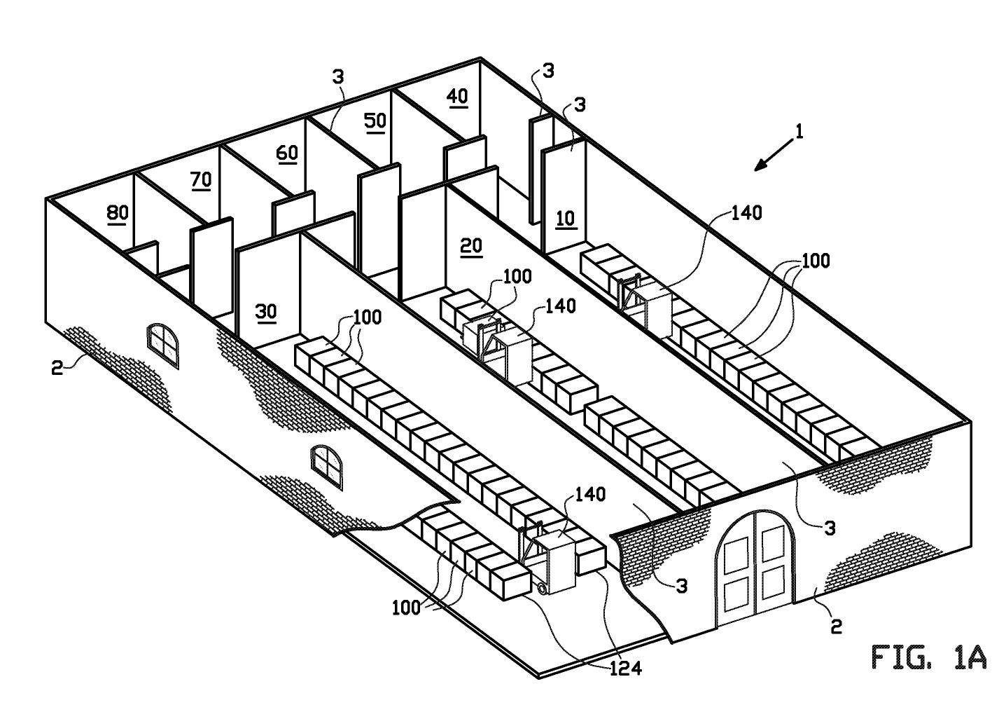

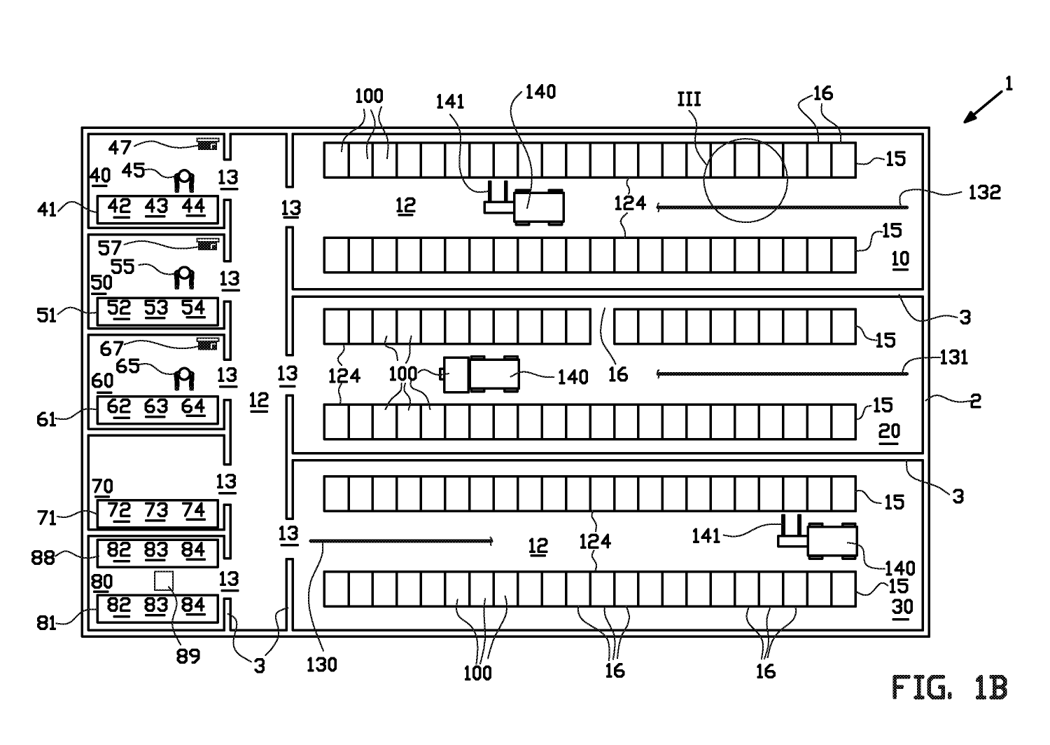

FIGS. 1A and 1B schematically show an example of a barn 1 for keeping indoor-fed livestock according to the invention, such as pigs. The barn 1 is provided with an exterior wall 2, several internal partitioning walls 3 and a roof that has been removed to show the internal structure of the pig barn 1.

In this example the barn 1 has a first housing area 10, a second housing area 20 and a third housing area 30 situated parallel to each other and in this example physically separated from each other by internal partitioning walls 3 for having pigs in different stages of life housed in them. Per housing area 10, 20, 30 the climate conditions and living conditions for the category of pigs in question have been optimised. The partitioning walls 3 can also be designed double so that in between them a technical facility corridor is present in which technical installations have been accommodated related to the stay of the animals in the barn 1.

In this example the first housing area 10 is intended for pregnant sows and sows with their suckling piglets. In the first housing area 10 the piglets have a weight between the weight at birth, which is approximately 1 kg, and the weight at which they will at first still suckle, which is approximately 8 kg. In the first housing area 10 an optimal air temperature for these animals of on average approximately 25 degrees Celsius prevails.

In this example the second housing area 20 is intended for young, weaned piglets in the first months of growth after suckling. In the second housing area 20 the piglets have a weight of between the aforementioned 8 kg and a weight at which they become porkers, which is approximately 25 kg. In the second housing area 20 an optimal air temperature for these animals of on average approximately 22 degrees Celsius prevails.

In this example the third housing area 30 is intended for porkers growing into their slaughter weight. In the third housing area 30 the pigs have a weight of between the aforementioned 25 kg and the slaughter weight of approximately 110 kg. In the third housing area 30 an optimal air temperature for these animals of on average approximately 22 degrees Celsius prevails.

In this example the first housing area 10, the second housing area 20 and the third housing area 30 have similarly been provided with two parallel racks 15 having a path 12 in between them. The racks 15 each comprises a row of designated barn positions 16 for living crates 100. The barn positions 16 are accessible from the path 12. On each barn position 16 one living crate 100 fits. In this example the racks 15 have one level, but the racks can also be provided with several floors so that the barn positions 16 can also be situated above one another.

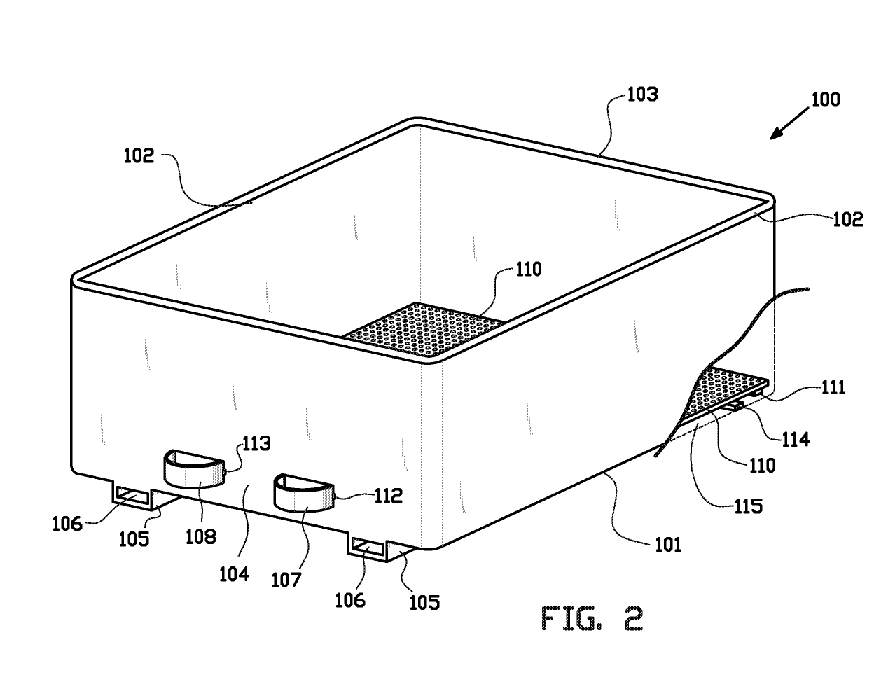

FIG. 2 shows a first living crate 100 according to the invention in detail. The living crate 100 comprises a closed integrally formed plastic tray having a bottom wall 101, two sidewalls 102, a rear wall 103 and a front wall 104 which for hygienic reasons merge into each other according to round corners. The round corners also ensure that the piglets do not walk around at a loss in the corners, so that stress in the animals is counteracted. Below the bottom wall 101 two sockets 105 extend having parallel insertion channels 106 for insertion of the lifting blades of a lifting device. As highly schematically shown a drink nipple or drinking water trough 107 and a feed trough 108 have been formed in the front wall 104, which are accessible from the inside for the pigs and which can also be replenished from the outside. The drink nipple or drinking water trough 107 can be connected to a pipe that via a coupling connects to a drinking water supply system outside of the living crate 100. The integrally formed tray is draught-free all around as a result of which a proper micro climate can also be preserved in the living crate 100 itself.

In the living crate 100 a perforated floor 110 is accommodated which extends at a distance from and parallel to the bottom wall 101 so that a storage space 115 for urine and faecal slurry is formed. The integrally formed living crate 100 can be properly cleansed due to the round corners and the removable floor 110. The living crate 100 is provided with a weight sensor 111 detecting the weight on the floor 110. The living crate 100 is provided with a faecal slurry level gauge 114 detecting the level of the faecal slurry layer in the storage space 115. The living crate 100 is provided with a drinking water level gauge 112 detecting the drinking water level in the drinking water trough 107. The living crate 100 is provided with a feed level gauge 113 detecting the quantity of feed in the feed trough 108. The weight sensor 111, the level gauges 112, 113, 114 and the drinking water supply system form a part of the aforementioned technical installation in the barn 1.

In the first housing area 10 there are one living crate 100 one pregnant sow or one sow with just her own group of piglets or her most recent litter. In the second housing area 20 the group of weaned piglets without the sow are staying in one living crate 100. When this group of piglets becomes too large, it will be split up into two half groups divided over two living crates 100, so that as many piglets from the same litter can remain together. This enhances the social wellbeing of the animals. In the third housing area 30 this division of groups is maintained, or the animals are divided over increasingly more living crates 100 towards the end of the stay in order to provide the animals with sufficient living space.

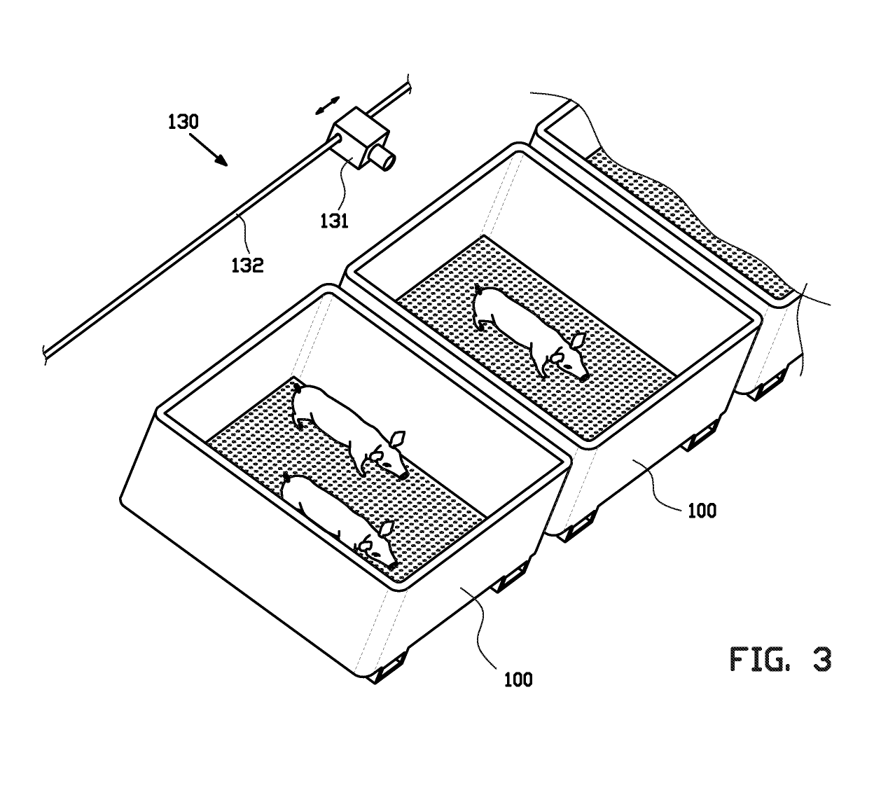

As shown in FIG. 3 the housing areas 10, 20 are provided with a camera system 130 for visual inspection of the living crates 100 and the pigs in them. In this example the camera system 130 comprises a camera 131 suspended from a rail 132 in which way the camera 131 can be moved above a path 12 along the parallel racks 15 with living crates 100. The camera system 130 is coupled to an automatic image recognition system that also automatically controls the movement of the camera 131 along the rails 132. The image recognition system is adapted for detecting visual deviations in the behaviour of the individual pigs in the living crates 100, such as limited or no motion activity or a deviating body temperature, which may be an indication of illness, or indeed too much motion activity, which is an indication of an imminent birth.

In this example at one head end the barn 1 has a first treatment area 40, a second treatment area 50, a third treatment area 60, a fourth treatment area 70 and a fifth treatment area 80 which in this example have been separated from each other by partitioning walls 3. Between the housing areas 10, 20 30 and the treatment areas 40, 50, 60, 70, 80 a path 12 has also been defined, wherein the access to the various areas 10, 20, 30, 40, 50, 60, 70, 80 can be closed off by intermediate doors 13.

In this example the first treatment area 40 is intended for a temporary stay of the sows just before and just after parturition or birth of her piglets under intensive human supervision. As also shown in FIG. 4 the first treatment area 40 is provided with a parturition lane in the form of a first transporter 41 having a reception position 42 for the living crates 100, an inspection position 43 for a human carer 45, and a discharge position 44 for the living crates 100. In this example the living crates 100 are on a transporter 41 at work level for the carer 45, but the living crates can also be placed on a support at work level. Important are the optimal conditions of wellbeing for the sow and her piglets on the one hand and the optimal working conditions for the carer 45 on the other hand.

In the first treatment area 40 an air temperature prevails of on average approximately 30 degrees Celsius that is optimal for these animals. In the first treatment area 40 heat lamps 48 are also present for local additionally warming the newly born wet and therefor vulnerable piglets. The heat lamps 48 preserve a micro climate within a draught-free tray of the first living crate 100. In the first treatment area lighting 49 is suspended fully spotlighting the contents of the living crates 100, so that the carer 45 is able to properly monitor the process in the living crates 100. Due to the work level of the living crates 100 the carer 45 is able to easily take actions in the living crates 100, such as drying or blow drying the newly farrowed piglet, or bringing the piglet to a teat. A computer terminal 47 is positioned for reading and entering details of the sows in the living crates 100. In the first treatment area all instruments required for the assistance in the farrowing process of piglets are furthermore present.

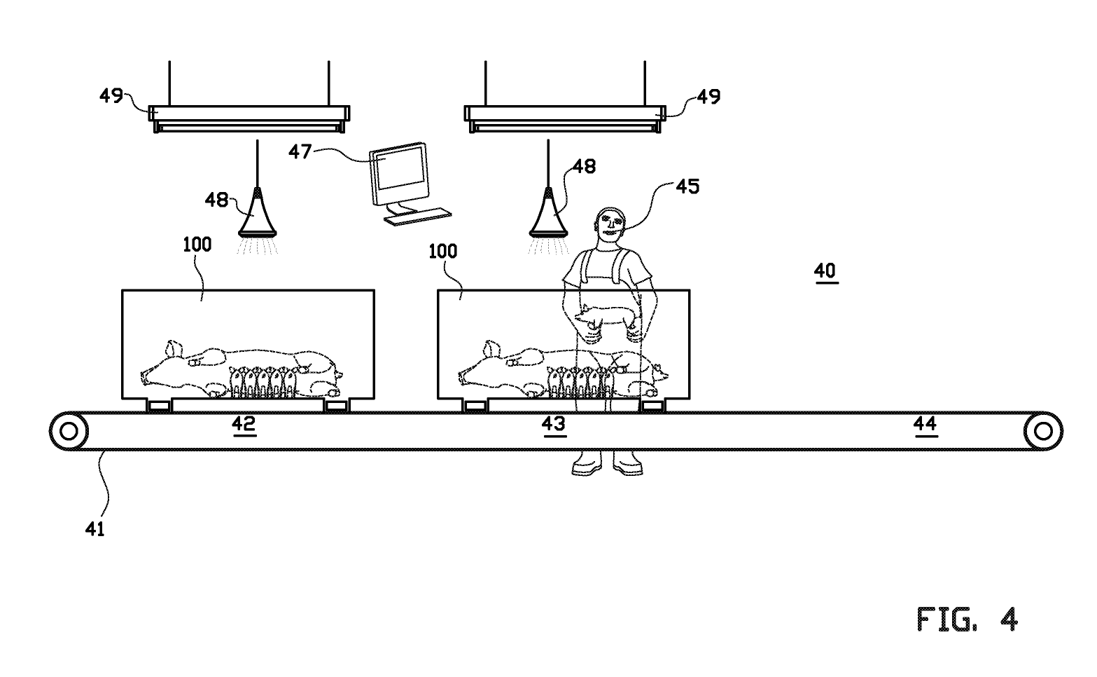

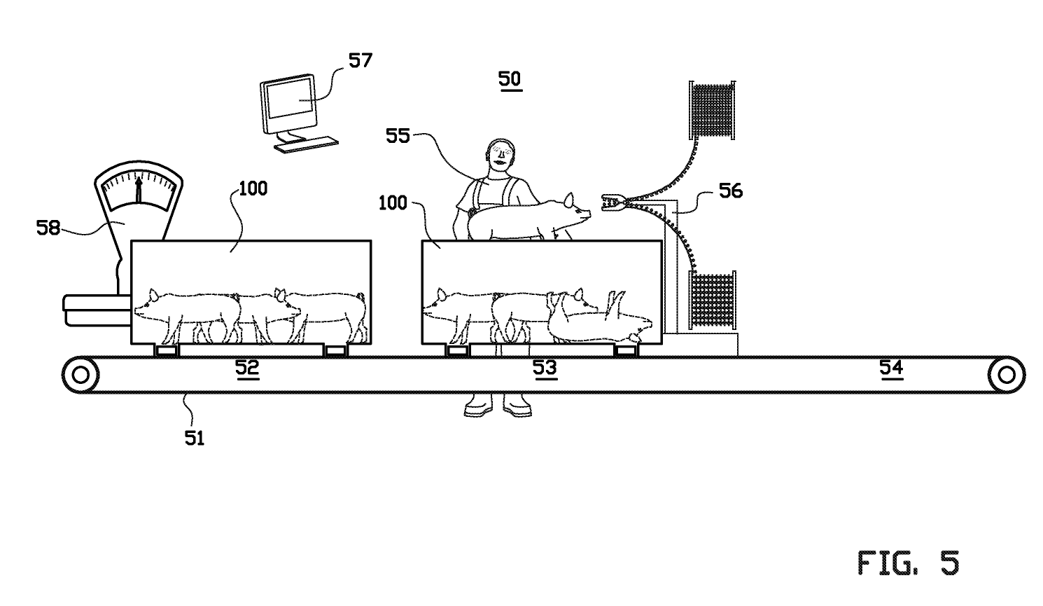

In this example the second treatment area 50 is intended for veterinary and nutritional inspection of pigs, ear tagging pigs, castration, clipping teeth and administering specific medicines after making a medical diagnosis. As also shown in FIG. 5 the second treatment area 50 is provided with a treatment lane in the form of a second transporter 51 having a reception position 52 for the living crates 100, a treatment position 53 for a human carer 55, and a discharge position 54 for the living crates 100. Scales 58 are present for weighing individual pigs. There is an ear tag machine 56 for applying ear tags and a computer terminal 57 is present for entering the unique ear tag data of the pigs in the living crates 100. The unique ear tag data are shown on the ear tag itself and can be read by radio technique at a short distance (RFID).

In this example the third treatment area 60 is intended for vaccination of pigs. The third treatment area 60 is provided with a vaccination lane in the form of a third transporter 61 having a reception position 62 for the living crates 100, a treatment position 63 for a human carer 65 administering vaccines or certain administerings such as iron without the use of a needle, and a discharge position 64 for the living crates 100. A computer terminal 67 is present for entering the treatment data of the pigs in the living crates 100.

In this example the fourth treatment area 70 is intended for cleansing the empty living crates 100. The fourth treatment area 70 is provided with a cleansing lane in the form of a fourth transporter 71 having a reception position 72 for the living crates 100, a cleansing position 73 including a cleansing machine 75, and a discharge position 74 for the cleansed living crates 100. The cleansing lane can also be used for just flushing the collected faecal slurry out of the storages space 115.

In this example the fifth treatment area 80 is intended for transferring the pigs between various living crates 100 or for transferring pigs from the living crates 100 to an external transport system in order to be removed from the barn 1. For that purpose the fifth treatment area 80 is provided with several transporters 81, 88 each having a reception position 82, a transfer position 83 and a discharge position 84 for the living crates 100 or for transportation crates. An automatic transfer device 83 for the transfer of pigs is placed between the transporters 81, 88.

In this example the functional housing areas 10, 20, 30 and the functional treatment areas 40, 50, 60, 70, 80 are physically separated from each other by means of the partitioning walls 3. However, these areas can also be planned in the same physical area, either partially or in groups, depending on the size of the barn and the required treatment capacity. The functional housing areas 10, 20, 30 and the functional treatment areas 40, 50, 60, 70, 80 will then be defined by for instance the prevailing micro climate and the specific equipment present.

In the barn 1 the pigs permanently stay in a living crate 100 positioned at one of the unique barn positions 16. In principle there are no humans present in the housing areas 10, 20, 30 so that exposure of the pigs to external pathogens or stress is kept to a minimum. It cannot be ruled out that humans carry out certain visual checks in the housing areas 10, 20, 30 in order to continuously guarantee the wellbeing of the pigs.

The barn 1 has several lifting transporters 140 capable of riding down the paths 12. The lifting transporters 140 are provided with two parallel lifting blades 141 that can be inserted into two parallel sockets 105 at the bottom side of the living crates 100. The lifting transporters 140 are thus able to place the living crates 100 at the various barn positions 16 in the first housing area 10, second housing area 20 or third housing area 30 and take the living crates 100 from and to one of the treatment areas 40, 50, 60, 70, 80 and pick them up again.

The lifting transporters 140 can be man-controlled or are automatically directed vehicles, remote-controlled vehicles or autonomously operating vehicles. Apart from internal transport, a part of the feeding and monitoring of the pigs can be carried out by means of the lifting transporters 140. The lifting transporters 140 can be provided with said camera 131 of the camera system 130, and the lifting transporters 140 can take care of the supplying of food and water to the living crates 100. In addition the lifting transporters 140 may be provided with dosage sensors in which way the individual replenishing of food and water per living crate 100 can be registered, and with a weight sensor for determining the weight of a living crate 100 on the lifting blades 141.

The weighing system can also be realised in the treatment areas 40, 50, 60, 70, 80 in order to limit the required number of weight sensors and thus periodically gain an insight into the weight development of the animals in the living crates 100.

The barn 1 is provided with a computer system having a database on which software runs. The computer system is linked to the camera system 130 for obtaining the results from the image recognition. The computer system is linked to the weight sensor 111, the faecal slurry level gauge 114, the water level gauge 112 or drink nipple, and the feed level gauge 113 of each living crate 100. The computer system is linked to the computer terminals 47, 57, 67 in the treatment areas 40, 50, 60. The computer system is linked to the lifting transporters 140 for passing on or automatically performing a transfer order for a living crate 100. The computer system is linked to the sensors of the lifting transporters 140.

The database comprises the individual data of each pig, including ear tag number, age, vaccination status, living crate 100 in which the individual pig stays and barn position 16 of the living crate 100 in one of the housing areas 10, 20, 30. The database furthermore contains data of each living crate 100, including the overall weight of the pigs in the living crate 100, the quantity of drinking water provided and the drinking water level, the quantity of feed offered and the feed level, the faecal slurry level, the temperature of the pigs present and the motion activity of the pigs. The motion activity is de degree of physical movement of the pig, such as the number of relocations of the animal in the living crate 100, or its limbs, in the course of time. They can be compared with an absolute standard or be related to the motion activity of the other animals in the same living crate 100.

The computer system continually registers and monitors the various parameters of the living crates 100, of the pigs in the living crates 100 and the behaviour and the temperature of the pigs in the living crates 100. On the basis thereof the computer system plans treatments for the living crates 100. A few examples thereof will be given below.

A first group of treatments will be determined ad hoc on the basis of deviations of the parameters relative to the nominal values related to the wellbeing of the pigs in the living crates 100. When a deviation is established, the computer system decides that the living crate 100 in question and the pig or pigs in there needs/need further veterinary inspection. A first situation is a deviating overall weight increase of the pigs in the living crate 100. A second situation is a deviating overall drinking water consumption or food consumption of the pigs in the living crate 100. A third situation is a deviating body temperature of one or several of the pigs in the living crate 100. A fourth situation is a deviating motion activity of one or several of the pigs.

The living crate 100 with the pigs in there, will then on the basis of the planning be removed from its designated barn position 16 by one of the lifting transporters 140 and be transported to the second treatment area 40. There the living crate 100 will be placed on the reception position 52 of the second transporter 51 after which the lifting transporter 140 is free again for a next transfer order. The living crate 100 is subsequently moved to the inspection position 53 where the veterinary specialist 55 will perform a further examination. One of the pigs may have a deviating weight or a fever, which may be an indication of illness. This pig can then be separated for intensified care. It is also possible that a pig has died. This pig will then be removed from the living crate for destruction. The diagnosis and intervention are registered using the computer terminal 57 on the basis of the unique ear tag of the pig in question. The veterinary specialist 55 can also find that the pigs in the living crate 100 are all healthy but that the living crate 100 has a technical problem, such as a faulty weight sensor 111, drinking water level gauge 112 or feed level gauge 113. Based on the technical diagnosis a follow-up treatment for the living crate 100 can be planned in the computer system. The living crate 100 with the pigs in there can then be picked up again from the discharge position 54 by a free lifting transporter 140 and be placed back at a planned free barn position 16 which does not necessarily need to be the same as the barn position 16 from which the living crate 100 originally came. The arrival at a new barn position 16 is registered again in the database.

A second group of treatments will be planned by the computer system according to fixed time schedules or as a result of earlier diagnosis.

A first planned treatment is the periodical veterinary inspection of all pigs in a living crate 100 in the manner as described above.

A second planned treatment is the assistance in the imminent farrowing of a pregnant sow. The living crate 100 with the pregnant sow will then on the basis of the planning be removed from its designated barn position 16 by one of the lifting transporters 140 and with the sow in there be taken to the first treatment area 40. The living crates 100 are placed under a heat lamp 48 and are spotlighted such with the lighting 49 that the carer 45 is able to properly monitor the wellbeing of the sow. After each birth the carer 45 is able to immediately pick up the cooling piglet, dry it off, briefly inspect it and bring it to a teat. After the parturition process, when the sow and her piglets are released by the carer 45 for that purpose, the living crate 100 is removed from under the heat lamp 48 and by one of the lifting transporters 140 is placed back at one of the barn positions 16 in the first housing area 10.

A third planned treatment is the ear tagging of newly born piglets in a living crate 100 in the first housing area 10. The living crate 100 with the pigs to be inspected will on the basis of the planning be removed from its designated barn position 16 by one of the lifting transporters 140 and with the sow and piglets in there be transported to the second treatment area 50. There the living crate 100 will be placed at the reception position 52 of the second transporter 51 after which the lifting transporter 140 is free again for a next transfer order. The living crate 100 is subsequently moved to the treatment position 53 where the carer 55 provides each piglet with an ear tag and enters the unique ear tag data into the computer system using the computer terminal 57. The living crate 100 is then taken back again by a lifting transporter 140 to a designated barn position 16 in the first housing area 10.

A fourth planned treatment is vaccination of pigs in a living crate 100 in one of housing areas 10, 20, 30. The living crate 100 with the pigs to be vaccinated will then on the basis of the planning be removed from its designated barn position 16 by one of the lifting transporters 140 and with the pigs in there be transported to the third treatment area 60. There the living crate 100 will be placed at the reception position 62 of the third transporter 61 after which the lifting transporter 140 is free again for a next transfer order. The living crate 100 is subsequently moved to the treatment position 63 where the carer 65 vaccinates each pig and enters the altered vaccination status into the computer system using the computer terminal 57. The living crate 100 is then taken back again by a lifting transporter 140 to a designated barn position 16 in one of the housing areas 10, 20, 30.

A fifth planned treatment is the periodical cleansing of the living crates 100 in which the pigs are staying. In general the living crates 100 will be cleansed as soon as they have been vacated because the pigs have been dispatched. The living crates 100 can also be cleansed in between times. The living crate 100 to be cleansed including the pigs will then be removed from its designated barn position 16 by one of the lifting transporters 140 and with the pigs in there be transported to the fifth treatment area 80. There the living crate 100 will be placed on one of the transporters 81, 88 after which the lifting transporter 140 is free again for a next transfer order. The transfer device 89 transfers the pigs to an already cleansed living crate 100 on the other transporter 82, after which one of the lifting transporters 140 picks up again said living crate 100 with the pigs in there from the discharge position 84 and takes it to a designated barn position 16. The living crate 100 and the pigs in there are registered in the computer system.

The living crate 100 to be cleansed is transferred by one of the lifting transporters 140 to the fourth treatment area 70 in order to be cleansed. The cleansed living crate 100 can then be returned to the fifth treatment area 80 for reception of pigs or be placed back empty at a designated barn position 16. Said status alteration is registered in the computer system.

A sixth planned treatment is the removal of faecal slurry from the storage space 115 of the living crate 100. The living crate 100 to be cleansed including the pigs will then be removed from its designated barn position 16 by one of the lifting transporters 140 and with the pigs in there be transported to the fourth treatment area 70. There the storage space 115 will be connected to a discharge and only the storage space 115 is flushed. The lifting transporters 140 subsequently place the living crate 100 back again at a planned barn position 16.

As has become clear from the description above, the pigs in the barn 1 permanently stay in the living crates 100 in the housing areas 10, 20, 30. The living crates 100 with the pigs in there are only transported to one of the treatment areas 40, 50, 60, 80 when this is required according to the planning in the computer system. The pigs are moved by the lifting transporters 140 while they remain in the living crate 100. In that way the paths 12 remain clean. The treatments can be planned ad hoc by the computer system if they are related to the wellbeing of the pigs in the living crates 100. For that purpose the first pre-selection of deviations of the parameters relative to the standard values takes place automatically. The treatments are furthermore planned by and using the computer system according to fixed time schedules or as a result of earlier diagnoses. In all cases the living crate 100 with the pigs in there is taken to the veterinary specialists 45 or carers 55, 65 in the treatment area dedicated to and equipped for that purpose.

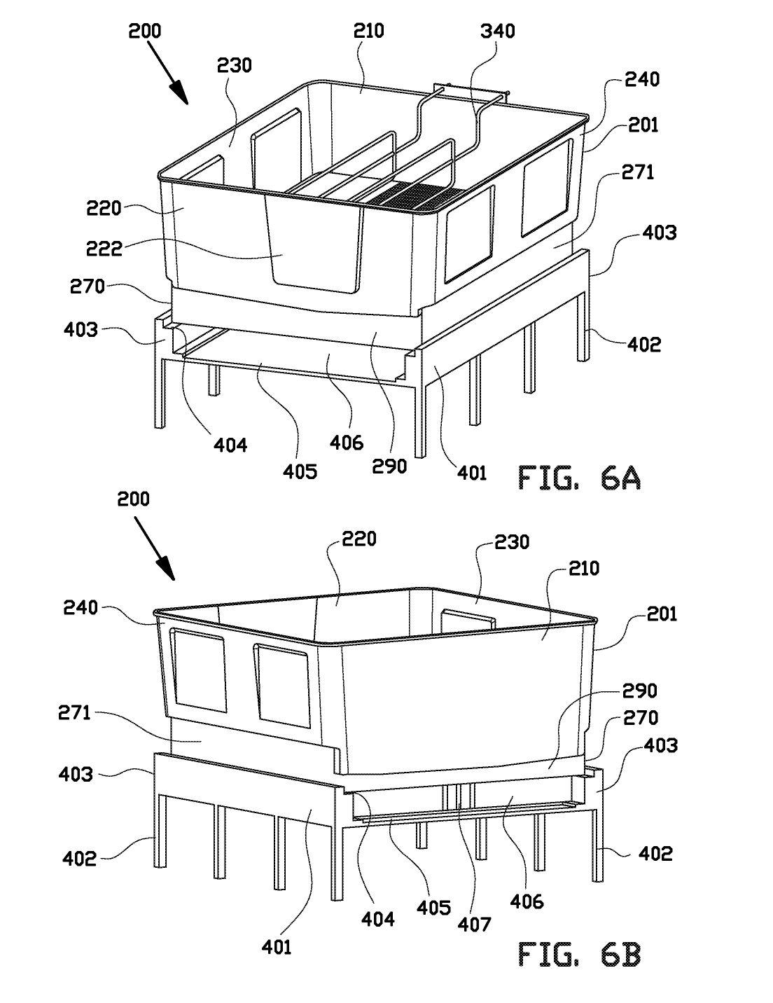

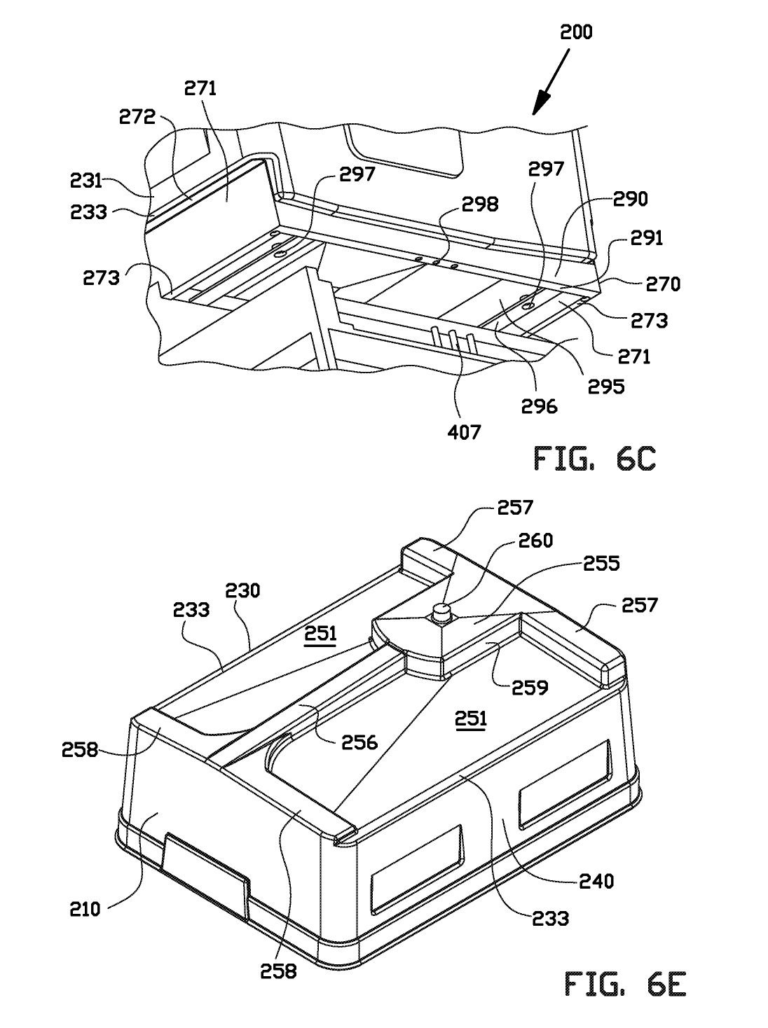

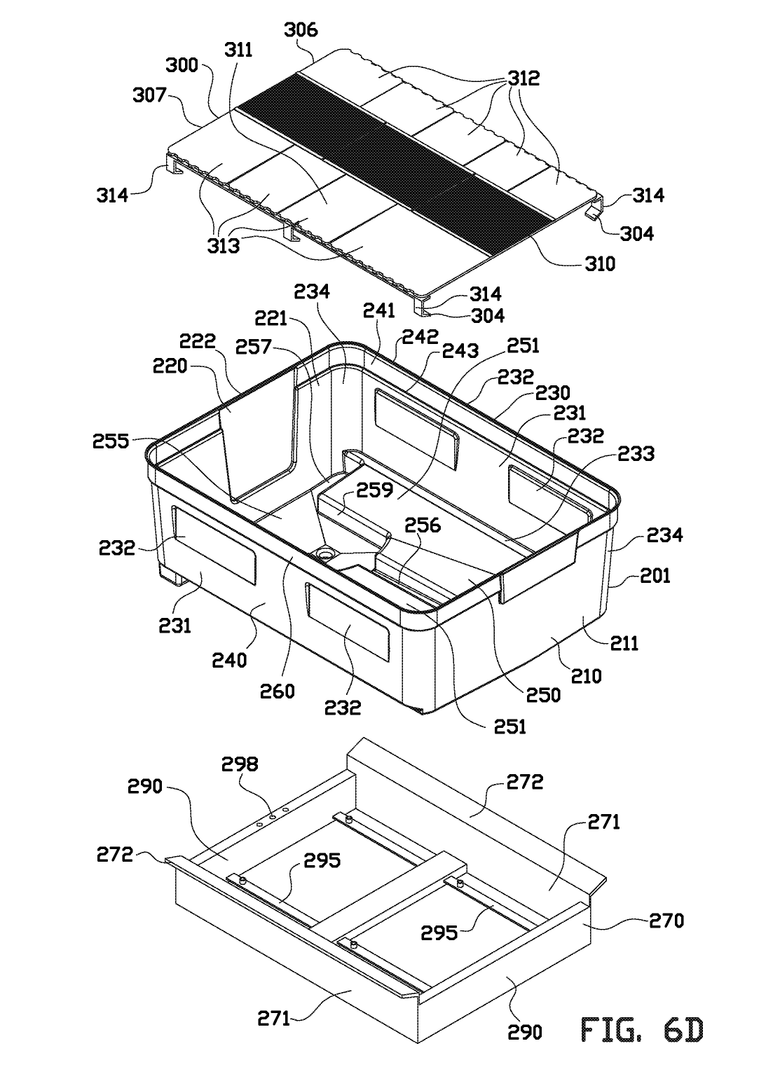

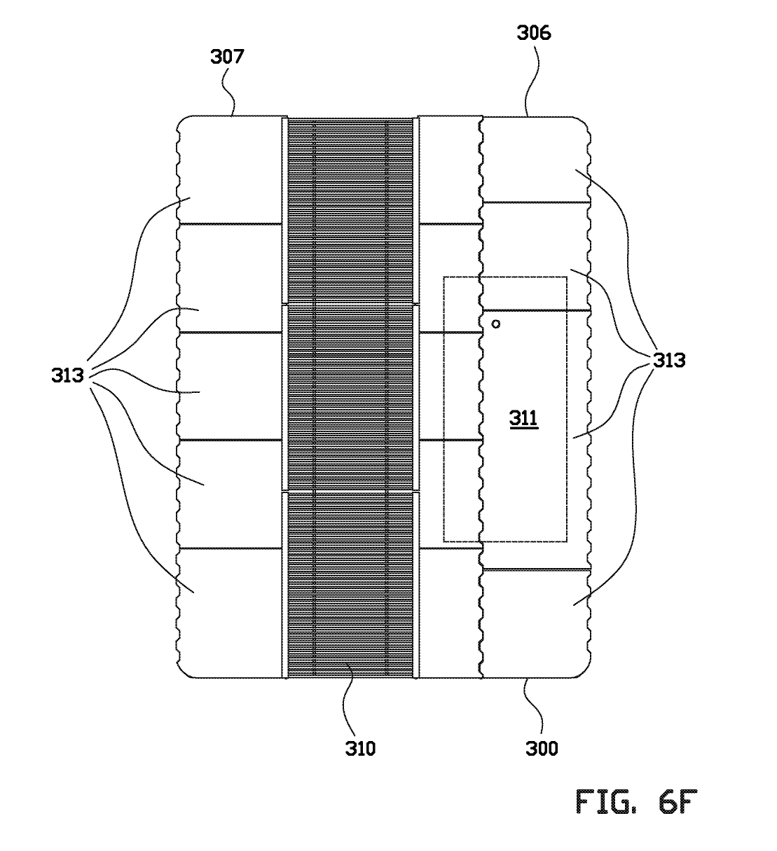

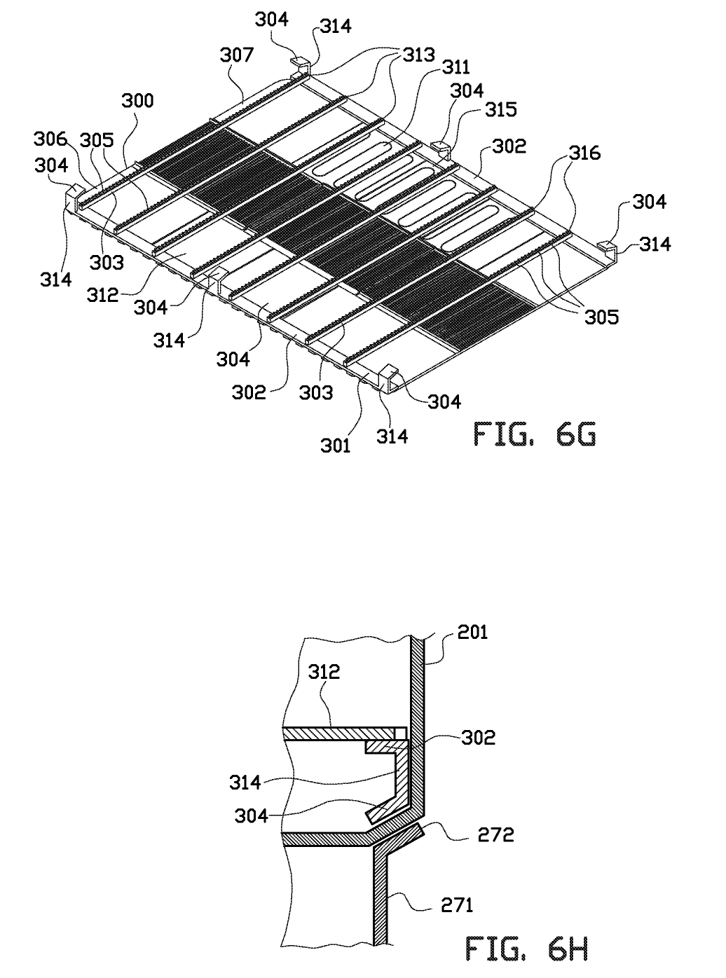

FIGS. 6A-6H show a second living crate 200 to be used in the barn 1 in the manner as described above. The living crate 200 comprises an integrally formed plastic tray 201 shown in detail in FIGS. 6D and 6E, and a steel frame 270 on which the plastic tray 201 is attached. The plastic tray 201 is made of for instance polyethylene (PE), polyvinylchloride (PVC) or fibre reinforced polyester (GRP), and has an overall substantially constant wall thickness and autonomous rigidity.

The plastic tray 201 comprises a front wall 210, a rear wall 220, a left sidewall 230, a right sidewall 240 and a bottom wall 250. The bottom wall 250 is built up asymmetrically, and comprises two platforms 251 that at the middle sides via a straight, vertical wall 259 merge into a faecal slurry tray 255 in the rear half of the bottom wall 250, a middle faecal slurry channel 256 with slope to the faecal slurry tray 255, two rearmost faecal slurry channels 257 along the rear wall 220 having a slope to the faecal slurry tray 255 and two foremost faecal slurry channels 258 along the front wall 210 with a slope to the middle faecal slurry channel 256. In the lowest portion of the faecal slurry tray 255 a faecal slurry discharge 260 with valve is situated. The more elevated platforms 251 have a slight slope in the direction of the middle faecal slurry channel 256 and the faecal slurry tray 255. Instead of one middle faecal slurry channel 256, several faecal slurry channels may also be provided next to one another.

The left sidewall 230 and the right sidewall 240 each have a straight wall section 231 and two offset reinforcement panels 232 formed in them. At the bottom side the straight wall sections 231 merge into a straight support edge 233 defining a part of the bottom wall 250. The support edge extends over the full length of the plastic tray 201. With their main planes the support edges 233 are placed inclined to the main plane of the connecting platforms 251 and wall sections 231. The front wall 210 has a straight wall section 211 that on both sides via a curve 234 merges into the straight wall sections 231 of the sidewalls 230, 240. The rear wall 220 has a straight wall section 221 that also on both sides via a curve 234 merges into the straight wall sections 231 of the sidewalls 230 and relative to the straight wall section 221 an offset panel 222 that can be cut out to form an access to the plastic tray 201. The curves 234 have a radius of at least 100 mm in order to counteract said walking around at a loss of the animals in the corners.

The plastic tray 201 has a circumferential upper wall 241 which at the upper side defines the upper edge 242 of the plastic tray 201 and which at the bottom side via an offset part 243 merges into the underlying walls 210, 220, 230, 240. Said offset part 243 can be cut through for, depending on the use of the living crate 200, forming a lowered upper edge of the plastic tray 201.

The steel frame 270 comprises two parallel first support profiles 271 which at the upper side are provided with an externally turned support lip 272. The plastic tray 201 is confined between the first support profiles 271 and then with the support edges 233 sits on said support lips 272. This is shown in detail in FIG. 6H. At the front end and the rear end the first support profiles 271 are connected to each other with second support profiles 290. At the upper side the second support profiles 290 follow the contour of the bottom wall 250. The second support profiles 290 are connected one to the other by means of third support profiles 295 extending parallel to the first support profiles 271. At their bottom side the support profiles 271, 290, 295 are provided with inwardly turned edges 273, 291, 296 forming the straight ground surface of the frame 270.

As shown in FIGS. 6A-6H the second living crate 200 is provided with a faecal slurry grid 300 in the plastic tray 201. A steel sow's pen 340 sits on the faecal slurry grid 300, the entrance of which sow's pen is in the extension of the offset panel 222 in the rear wall 220. In this example the sow's pen 340 is off-centre so that on one side of the sow ample space is available for her suckling piglets. The sow's pen 340 can also be in the centre. In both positions there will be ample space to allow all piglets to lie in one piglet litter.

As shown in FIG. 6G the faecal slurry grid 300 comprises a steel frame 301 built up with two steel longitudinal profiles 302 connected parallel to each other by means of parallel steel transverse profiles 303. At the longitudinal profiles 302, support lips 314 that are transversely oriented thereto, are provided. The support lips 314 have a diagonally turned outer end 304. The faecal slurry grid 300 is confined within the sidewalls 230, 240, and the front wall 210 and rear wall 220, respectively, of the plastic tray 201, wherein all around an annular slit is present that is narrower than 1 cm in order to prevent the legs of the piglets from getting wedged in them. As shown in FIG. 6H the turned ends 304 are then parallel to and straight on the support edges 233 of the plastic tray 201, and the support edges 233 are parallel to and on the support lips 272 of the frame 270. The overall weight of the faecal slurry grid 300 and the animals is thus passed on vertically and directly to the frame 270 without a deforming load on the tray 201. The free spaces between the consecutive support lips 314 ensure that the faecal slurry is able to slide down along the sidewalls 230, 240 to the underlying platforms 251. The full space underneath the faecal slurry grid 300 can be used for the temporary storage of faecal slurry.

The support edges 233 form the only bearing points of the faecal slurry grid 300. Along the sidewalls 230, 240 of the plastic tray 201, the faecal slurry grid 300 is provided with a wide path 307 of steel or plastic grid plates 313 and a narrower path 306 of steel or plastic grid plates 312 that are adjacent to the sow's pen 340. Between these paths 306, 307 of steel grid plates 312, 313 there is a cast iron grid plate 310 on the transverse profiles 302 which plate extends underneath the sow's pen 340. The steel grid plates 313 are welded to the frame 301 and form one unity therewith. If they are made of plastic they are secured to the frame 301. The cast iron grid plate 310 forms an insert piece.

In the middle the wider path 307 of grid plates 313 is provided with a heated zone 311. The heat comes from a hot water pipe 315 attached underneath it. The faecal slurry grid 300 is furthermore provided with parallel rinse water pipes 316. The pipes 315, 316 are welded to the bottom side of the transverse profiles 303 as a result of which they form one unity therewith. The assembly of the steel frame 301 the grid plates 313 and the pipes 315, 316 after assembling has been subjected to a joint coating treatment or, in case of steel grid plates 313, a joint galvanisation treatment so that an all-round durably protected unity has been formed. In this example the faecal slurry grid 300 is provided with a cast iron grid plate 310 and steel or plastic grid plates 313. The grid plates can also be made of a different material or of the same material. An alternative example are metal wire grids that can be provided with a thick plastic coating.

Nozzles 305 oriented towards the bottom wall 250 are connected to the rinsing pipes 316. Via a connection that is not shown the rinse water pipe 316 and the outer ends of the hot water pipe 315 are connected to rapid couplings or spigot and socket couplings 298 on the second support profile 290 extending underneath the rear wall 220. By means of said rapid couplings the pipe to the drinking nipple or drinking water trough in the living crate 100, 200 can also be connected.

As also shown in FIGS. 6A and 6B the second living crate 200 can be positioned elevated on a stand 401. The stand 401 comprises two bearing profiles 403 on which the first support profiles 271 sit. The first support profiles 271 sit in a recess at the upper side of the bearing profiles 403 in order to confine them. At their bottom sides the bearing profiles 403 are connected one to the other to transverse profiles 405 keeping an insertion space 406 free to be able to pick up the second living crate 200 from below using the said lifting transporters 140 or by means of a transport device further elucidated below. The stand 401 is provided with rapid couplings or spigot and socket couplings 407 that directly connect to the rapid couplings 298 of the second living crate 200 when it is placed thereon. From there the living crate 200 is provided with hot circulation water for the heated zone 311 and with rinse water for the nozzles 305. The steel frame 270 and the stand 401 are provided with cooperating cams 297 for the correct placement of the living crate 200 on the stand 401.

The faecal slurry tray 255 can be emptied by connecting its faecal slurry discharge 260 to a drain pipe or by placing it over a toilet. The rinse water can be supplied via the nozzles 305 after opening the valve. Alternatively the rinse water is supplied via a showerhead having a nozzle hosing water all around. Said showerhead is inserted from below through the faecal slurry discharge 260 in order to hose the faecal slurry tray 255 and the adjacent parts clean all around.

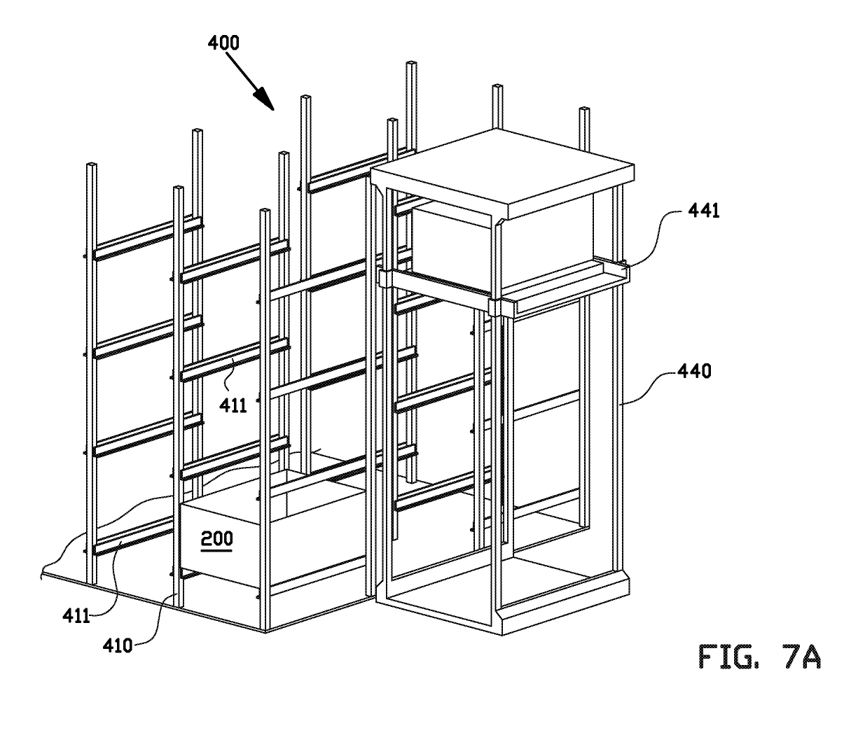

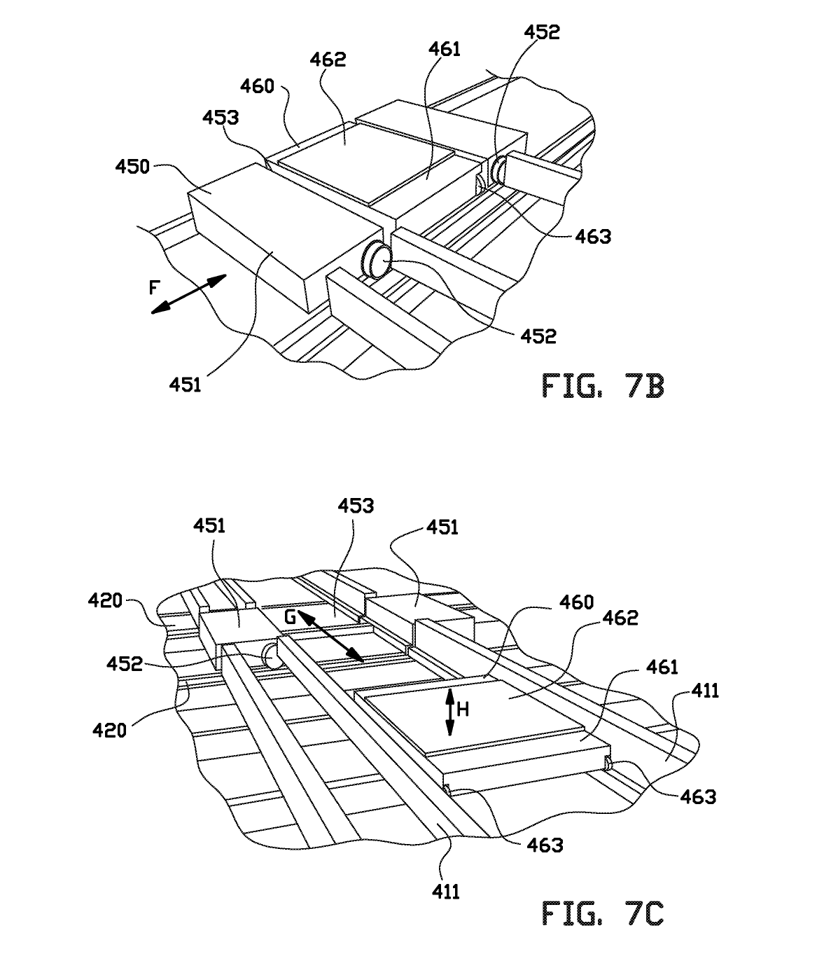

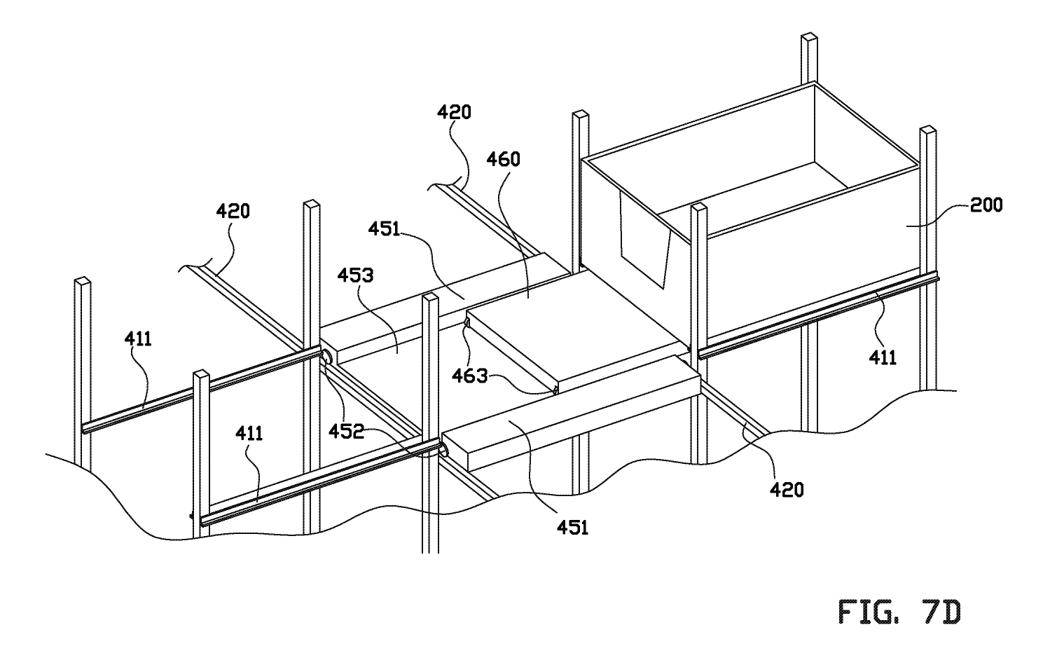

FIGS. 7A-7D show an alternative transport device 400 to be used in the barn 1. The transport device 400 comprises parallel racks 410 each having several horizontal bearing rails 411 above one another. Each pair of bearing rails 411 forms a barn position 16 for a living crate 100, 200. The transport device 400 is provided with horizontal transport rails 420 extending along the bearing rails 411. The transport rails 420 connect to a lift 440.

A first transport carriage 450 is able to ride over the transport rails 420 in direction F. The first transport carriage 450 comprises two housings 451 having four driven wheels 452 and a recess 453 in between them which can be brought in the extension of the bearing rails 411. A second transport carriage 460 is then able to ride in and out of the recess 453 in direction G. The first transport carriage 450 and the second transport carriage 460 can be man-controlled, or they are remote-controlled carriages or autonomously operating carriages. The second transport carriage 460 comprises a housing 461 having four driven wheels 463 and a lifting table 462. The lifting table 462 is movable in direction H between a retracted position in which the second transport carriage 460 is able to ride over the bearing rails 411 underneath a second living crate 200, and a lifted position in which it keeps the living crate 200 on the frame 270 free above the bearing rails 411. The living crate 200 can thus be moved from and towards its barn position 16. Rapid couplings 407 have also been provided at the barn positions 16. When lifting and lowering in direction H the rapid couplings 298 are automatically connected thereto or disconnected therefrom.

The lift 440 has a man-operated or remote-controlled or autonomously operating lifting platform 441 on which the first transport carriage 450, with the second transport carriage 460 on there bearing the living crate 200, can be driven. The lowest level of the lift 440 is connected to rails that are not further shown and lead to the treatment areas 40, 50, 60, 70. In the treatment areas, in particular the first treatment area 40 where parturition takes place, the living crates 200 are on stands 401.

The above description is included to illustrate the operation of preferred embodiments of the invention and not to limit the scope of the invention. Starting from the above explanation many variations that fall within the spirit and scope of the present invention will be evident to an expert.

1-44. (canceled)

45. Method for keeping livestock in a barn, wherein the barn is divided into one or more housing areas for multiple-day stays of the animals and one or more treatment areas for a shorter, temporary stay of the animals for veterinary inspection of or caring for the animals by a specialist or carer, wherein the animals are staying in living crates positioned on designated barn positions in the housing areas, wherein the barn is provided with a transport device for moving the living crates between the barn positions and the treatment areas, wherein a computer system including a database is provided in which data are included of the barn positions of the living crates and of the individual animals in the living crates, wherein the method comprises monitoring the animals' data in the computer system and on the basis thereof by using the computer system planning a temporary stay of the animals in the living crates in a treatment area for inspection or care, wherein on the basis of said planning the living crates with the animals in them are picked up from the barn position in the housing area by the transport device and in the living crates are positioned in the said treatment area for inspection of or caring for the animals.

46. Method according to claim 46, wherein the barn is provided with a sensor system for registering the condition data regarding the condition of the living crates or the animals in them in the database, wherein the method comprises the planning of a temporary stay of the animals in the living crates in a treatment area on the basis of the condition data.

47. Method according to claim 46, wherein the sensor system comprises a weight sensor for weighing the overall weight of the animals in the living crate, wherein the method comprises the planning of a temporary stay of the animals in the living crates in a treatment area on the basis of deviating weight of the animals in the living crates.

48. Barn for keeping livestock, wherein the barn is divided into one or more housing areas for multiple-day stays of the animals and one or more treatment areas for a shorter, temporary stay of the animals for veterinary inspection of or caring for the animals by a specialist or carer, wherein the animals are staying in living crates positioned on designated barn positions in the housing areas, wherein the barn is provided with a transport device for moving the living crates between the barn positions and the treatment areas.

49. Barn according to claim 48, comprising several housing areas, wherein the air temperatures of the housing areas differ or can each be individually adjusted.

50. Barn according to claim 48, wherein at least one treatment area is adapted for parturition, wherein the air temperature in said treatment area is higher than in the housing areas.

51. Barn according to claim 48, wherein the living crates comprise a tray having a bottom which is surrounded by upright walls, wherein in the tray a faecal slurry grid is situated above the bottom.

52. Barn according to claim 51, wherein the faecal slurry grid comprises a first frame bearing a grid, wherein the first frame supports on the bottom along or at the upright walls, and the faecal slurry grid freely spans the bottom from the support points so as to form a faecal slurry storage space or faecal slurry tray, wherein the living crate has a second frame for supporting the tray, wherein the second frame supports the bottom of the tray in vertical direction straight below the support points of the faecal slurry grid.

53. Barn according to claim 52, wherein the first frame is provided with supports that contact the bottom along two opposite upright walls.

54. Barn according to claim 53, wherein the first frame is provided with supports distributed over and contacting the bottom wall along the opposite upright walls, wherein the distributed supports keep an intermediate space open for passage of faecal slurry to the faecal slurry storage space or faecal slurry tray.

55. Barn according to claim 51, wherein the living crate comprises a sow's pen as a result of which the faecal slurry grid is divided into a first grid path and a second grid path extending beyond the sow's pen.

56. Barn according to claim 55, wherein in one sidewall the tray has an entrance to the sow's pen, wherein in its bottom the tray comprises a faecal slurry channel extending underneath the sow's pen, which faecal slurry channel debouches in the direction of the entrance into a wider faecal slurry tray, wherein the bottom underneath the first grid path and second grid path is situated elevated relative to the faecal slurry channel and the faecal slurry tray and has a slope in the direction of the faecal slurry channel and the faecal slurry tray.

57. Barn according to claim 51, wherein the tray comprises two longitudinal walls and two transverse walls, which according to round corners merge into each other, wherein the corners have a radius of at least 100 mm.

58. Barn according to claim 51, wherein the tray is integrally formed.

59. Barn according to claim 51, wherein the tray is integrally formed of plastic.

60. Living crate for keeping livestock in a barn, comprising a tray having a bottom which is surrounded by upright walls, wherein in the tray a faecal slurry grid is situated above the bottom.

61. Living crate according to claim 60, wherein the faecal slurry grid comprises a first frame bearing a grid, wherein the first frame supports on the bottom along or at the upright walls, and the faecal slurry grid freely spans the bottom from the support points so as to form a faecal slurry storage space or faecal slurry tray, wherein the living crate has a second frame for supporting the tray, wherein the second frame supports the bottom of the tray straight below the support points of the faecal slurry grid.

62. Living crate according to claim 61, wherein the first frame is provided with supports that contact the bottom wall along two opposite upright walls.

63. Living crate according to claim 62, wherein the first frame is provided with supports distributed over and contacting the bottom wall along the opposite upright walls, wherein the distributed supports keep an intermediate space open for passage of faecal slurry to the faecal slurry storage space or faecal slurry tray.

64. Living crate according to claim 60, wherein the tray is integrally formed of plastic.
